(19) United States
(12) Patent Application Publication
(10) Pub. No.: US 2024/0018845 A1
(43) Pub. Date: Jan. 18, 2024

(54) GEOPOLYMER WELL BORE PLACEMENT AND SEALING

(71) Applicants: Magnum Cementing Services Operations Ltd., Strathmore (CA); National Silicates Partnership, Etobicoke (CA)

(72) Inventors: Shaun T. Mesher, Calgary (CA); Michael McDonald, Toronto (CA)

(21) Appl. No.: 18/223,519

(22) Filed: Jul. 18, 2023

Related U.S. Application Data
(60) Provisional application No. 63/390,284, filed on Jul. 18, 2022.

(51) Int. Cl. E21B 33/14; C04B 28/00; C04B 28/26; C04B 12/00; C04B 12/04

(52) U.S. Cl. CPC E21B 33/146; C04B 28/006; C04B 28/26; C04B 12/005; C04B 12/04; C04B 2111/40

(57) ABSTRACT

A method of producing a material. The material is produced by the steps of: providing a geopolymer mixture or solution comprising an aluminosilicate and an alkali material; allowing the geopolymer mixture or solution to partially set to form an at least partially set geopolymer including pore spaces; and exposing the at least partially set geopolymer to a metal silicate solution or mixture containing a metal silicate to allow the metal silicate to enter the pore spaces and react to form additional material within the pore spaces. The material may be used in well-cementing and as an abandonment plug.

### PRIORITY CLAIM

This application claims the benefit of priority from U.S. provisional patent application No. 63/390,284, filed Jul. 18, 2022, the contents of which are incorporated herein by reference.

### FIELD OF THE INVENTION

The field is related to methods of use of geopolymers, particularly where low porosity is desirable such as in oil field applications including well-cementing operations and abandonment plug operations.

### BACKGROUND OF THE INVENTION

Due to the increasing demand of materials with a reduced carbon footprint and low energy consumption, a burgeoning interest has been observed from academia and industry to develop, characterize, and implement novel sustainable construction materials, which are prerequisites for modern infrastructure with new standards. One of these new proposed materials is geopolymer, a synthetic alkali aluminosilicate material produced by the reaction of aluminosilicate sources with highly concentrated aqueous alkali hydroxide and/or alkali metal silicate solutions. Depending on the mix design and processing conditions, geopolymers can exhibit different properties such as high early-compressive strength, acid resistance, sound insulation, heat insulation and fire resistance. These properties enable the geopolymer to be used in applications such as in situ and precast construction, refractories and high-temperature applications, soil stabilization, pavement systems, and 3D printing.

Geopolymers are formed from a solution containing an aluminosilicate source, a metal silicate, an alkali metal and a carrier fluid such as water.

The ingredients that make up a geopolymer can include for example: an alkaline solution, e.g., sodium hydroxide or potassium hydroxide, aluminum or silica oxide minerals which include clay type materials, fly ash, blast furnace slag or a kaolinite, and an alkali metal silicate to initiate the geopolymer process.

Alkali metal silicates may be used as promoters, and are typically either sodium or potassium because these are the most common. Lithium silicate can also be used but is more expensive. Sodium and potassium silicates typically have an upper limit for solubility in water close to 1:1 by weight, but solid forms can be included in a mixture to increase concentrations. An alkali silicate can be used for example in liquid solution, spray dried or ground glass forms.

A promoter is not needed if the clay source has metals in it like calcium for example that makes the process react faster. A geopolymer based on blast furnace slag which contains 30-45% calcium oxide would only need slag and an alkaline solution such as NaOH in water to form a geopolymer.

Cementing operations are varied and can involve the placement of pipe strings, such as casing and liners in new oil and gas wells, followed by pumping cement from the surface to circulate between the well bore subterranean formation and the pipe string. The cement is then allowed to harden and fix (bond) these pipe strings in place.

Remedial cementing such as an abandonment, involves setting plugs and sealing voids in oil and gas wells that are no longer in use or planning to be decommissioned. Cement used in remedial applications is pumped downhole and squeezed into an area that is “open” to the surface via the existing well bore. The cement is allowed to harden, thereby sealing and isolating the formation from the open well bore. One of the most important aspects of cementing is that the hardened material is substantially impermeable to formation gases and liquids.

Portland cement is the main ingredient used in a cementing job and is typically used in all the above applications for a variety of reasons because it provides a solution that is economical, functional in most cases and is well understood. A main problem with using Portland cement is that it is vulnerable to attack by corrosive chemicals typically found downhole in subterranean formations and can undergo changes over time that causes the applied cement to fail. The result is lack of zonal isolation and the need for costly remedial cement application.

The use of geopolymer in wellbore solutions is a relatively new technology and U.S. Pat. No. 7,794,537, issued in 2010 started the investigation into various formulations of geopolymer for use as an alternative to using cement in well bore applications. U.S. Pat. No. 9,840,653 and Canadian Patent Application Number 3,024,537A1 expand on the proposed use of geopolymers in well bore applications.

The minimal use of geopolymers currently, compared to Portland cement, indicates that geopolymer use generally is still a long way off and is only used in special circumstances.

One of the main properties that is measured in geopolymers, is the compressive strength of the geopolymer, which is an important property when trying to bond the pipe to subterranean formations. Compressive strength is measured over the course of days and with geopolymers it is found that the strength continues to get better as the geopolymer ages.

An overlooked property of geopolymers is the amount of porosity contained within the hardened geopolymer.

Porosity is inherent in all geopolymers; for influences on porosity see for example Dudek M, Sitarz M. Analysis of Changes in the Microstructure of Geopolymer Mortar after Exposure to High Temperatures. Materials (Basel). 2020 Sep. 24; 13(19):4263. doi: 10.3390/ma13194263. PMID: 32987886; PMCID: PMC7579173. In fact, there is a lot of research directed to increasing porosity, see for example Xiaohong Zhang, Chengying Bai, Yingjie Qiao, Xiaodong Wang, Dechang Jia, Hongqiang Li, Paolo Colombo, Porous geopolymer composites: A review, Composites Part A: Applied Science and Manufacturing, Volume 150, 2021, 106629, ISSN 1359-835X, https://doi.org/10.1016/j.compositesa.2021.106629, and the technology to achieve additional porosity. U.S. Pat. No. 10,100,602 shows how certain metals can be added to the geopolymer paste to generate additional hydrogen gas in specific well bore applications.

Porous geopolymers are used for applications ranging from sound insulation to thermal insulation, the most famous of which would be the thermal tiles used on all the space shuttles. In most well bore applications porosity is an undesirable property and must be minimized.

One property of geopolymers is the ability to self-heal overtime, this relates to the geopolymers continuing ability to grow its polysilates (polymeric silica alumina) chains, U.S. Pat. No. 7,794,537. Because of this property, geopolymers that initially contain porosity show a slowly declining porosity as the matrix develops its final microstructure. This is usually achieved in 21-60 days once the geopolymer is set. In well bore applications this time frame is not practical, nor economic.

### SUMMARY OF THE INVENTION

In one embodiment there is disclosed a method of producing a material, the method comprising the steps of: providing a geopolymer mixture or solution comprising an aluminosilicate and an alkali material such as an alkali hydroxide; allowing the geopolymer mixture or solution to partially set to form an at least partially set geopolymer including pore spaces; and exposing the at least partially set geopolymer to a metal silicate solution or mixture containing a metal silicate to allow the metal silicate to enter the pore spaces and react to form additional material within the pore spaces.

In various embodiments, there may be included any one or more of the following features: the geopolymer mixture or solution also includes an alkali silicate; the metal silicate comprises sodium silicate, potassium silicate or lithium silicate; the metal silicate solution or mixture is a solution that includes a concentration of the metal silicates from 1 to 50% by weight in water; the metal silicate solution or mixture is a solution that includes a concentration of the metal silicates from 15 to 30% by weight; the concentration of the metal silicates is about 20% by weight; the step of allowing the mixture to partially set to form an at least partially set geopolymer including pore spaces is carried out at a pressure of at least 100 psi; the step of allowing the mixture to partially set to form an at least partially set geopolymer including pore spaces is carried out at a pressure of at least 500 psi; the step of allowing the mixture to partially set to form an at least partially set geopolymer including pore spaces is carried out at a pressure of at least 1000 psi; the step of allowing the mixture to partially set to form an at least partially set geopolymer including pore spaces is carried out at a pressure of about 1500 psi; the step of allowing the mixture to partially set to form an at least partially set geopolymer including pore spaces is carried out at a pressure of greater than natural well bore conditions; the step of allowing the mixture to partially set to form an at least partially set geopolymer including pore spaces is carried out at a pressure of less than 3000 psi; the step of exposing the at least partially set geopolymer to a solution containing a metal silicate to allow the metal silicate to enter the pore spaces and react to form additional material within the pore spaces is carried out without a substantial change in pressure from the step of allowing the mixture to partially set to form an at least partially set geopolymer including pore spaces; the material is formed in a wellbore to seal the wellbore; the geopolymer mixture or solution is provided in a lower portion of the wellbore, and the metal silicate mixture or solution is provided in a further portion of the wellbore immediately above the lower portion; the further portion is at least 5m in length; the further portion is between 5 and 50m in length; the geopolymer mixture or solution is supplied into the wellbore through a tube, the geopolymer mixture or solution preceded through the tube by a preflush comprising the metal silicate mixture or solution and followed by a spacer comprising the metal silicate mixture or solution; and the step of removing the tube before the step of allowing the mixture to partially set to form an at least partially set geopolymer including pore spaces. A length of greater than 50 m could be desired to help with corrosion control of the wellbore.

The foregoing summary is not intended to summarize each potential embodiment or every aspect of the subject matter of the present disclosure.

### BRIEF DESCRIPTION OF THE DRAWINGS

Preferred and alternative examples of the present invention are described in detail below with reference to the following drawings. Furthermore, embodiments will now be described with reference to the figures, in which like reference characters denote like elements, by way of example, and in which:

FIG. 1 is a flow chart showing an embodiment of the method of producing a material.

FIG. 2 is a side view of an embodiment of a geopolymer in a well bore with the tubing inserted.

FIG. 3 is a side view of an embodiment of a geopolymer in a well bore with the tubing partially removed.

FIG. 4 is a chart showing the fluid loss after a 24 hour set time.

FIG. 5 is a flow chart showing an embodiment of a method of placing a geopolymer in a wellbore.

### DETAILED DESCRIPTION OF THE PREFERRED EMBODIMENT

The methods disclosed herein relate to the use of geopolymers in oil, gas and geothermal field applications in particular the use in cementing operations where the geopolymer is set under conditions that minimize porosity within the geopolymer matrix.

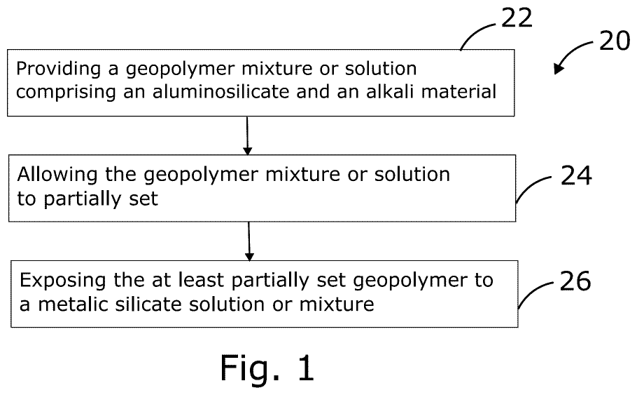

Referring to FIG. 1, an embodiment of a method of producing a material 20 is shown. In a first step 22, a geopolymer mixture or solution comprising an aluminosilicate and an alkali material may be provided. The alkali material may be, for example, an alkali hydroxide. The geopolymer mixture or solution may also include an alkali silicate. In a next step 24, the geopolymer mixture or solution may be allowed to partially set to form an at least partially set geopolymer including pore spaces. The step 24 may be carried out at a pressure of at least 100 psi, at least 500 psi, at least 1000 psi, at least 1500 psi, or at a pressure of greater than natural well bore conditions. The step 24 may also be carried out at a pressure of less than 3000 psi.

In a next step 26, the at least partially set geopolymer may be exposed to a metal silicate solution or mixture containing a metal silicate to allow the metal silicate to enter the pore spaces and react to form additional material within the pore spaces. The metal silicate may comprise sodium silicate, potassium silicate or lithium silicate. The metal silicate solution or mixture is a solution that may include a concentration of the metal silicates from 1 to 50% by weight. The metal silicate solution or mixture may additionally be a solution that includes a concentration of the metal silicates from 15 to 30% by weight. The concentration of the metal silicates may also be about 20% by weight. The step 26 may be carried out without a substantial change in pressure from the step 24 of allowing the mixture to partially set to form an at least partially set geopolymer including pore spaces.

Where referred to herein, the geopolymer prior to setting may be in the form of a mixture, solution, cement, or paste.

A metal silicate solution may be in the form of a solution or mixture containing at least a metal silicate or metal silicates.

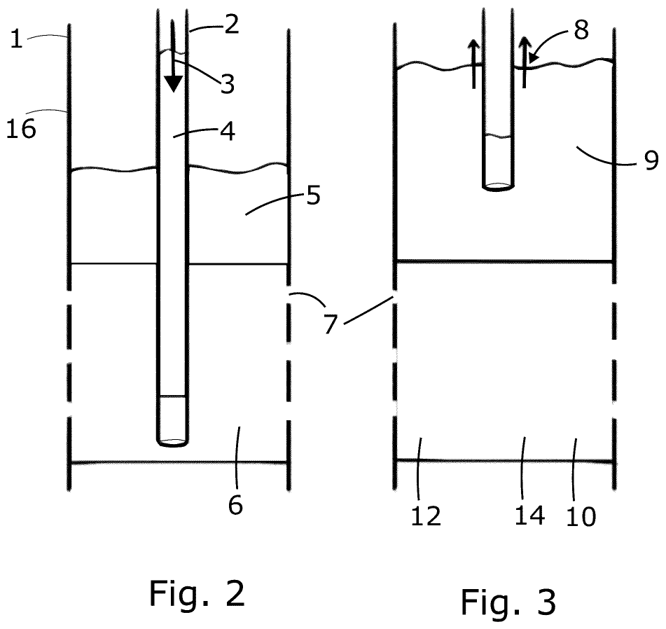

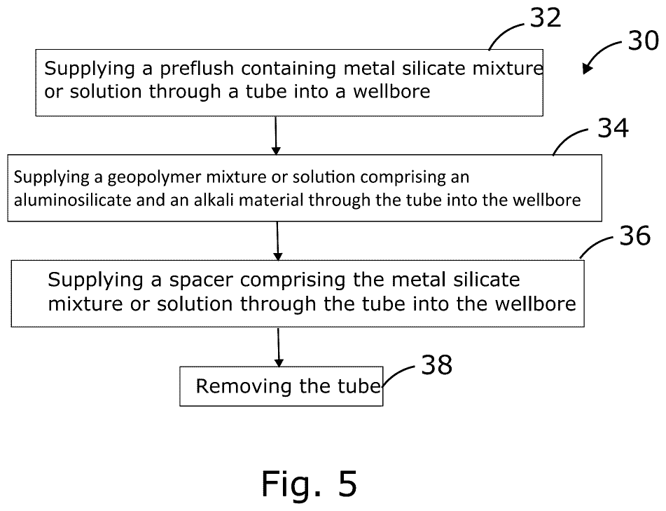

The material 20 may be formed in a wellbore 16 to seal the wellbore 16 as is shown in FIGS. 2 and 3. An embodiment of a method 30 of supplying the material 20 into a wellbore 16 is illustrated in FIG. 5.

The material 20 may be used, for example, to create an oil or gas well abandonment plug. This can be achieved operationally by using a metal silicate solution preflush 5 and a metal silicate solution spacer 4 to sandwich the pumped geopolymer 6. Any method or layering order of the metal silicate solution and geopolymer may be used that that causes the partially set geopolymer 10 to at least partially contact the metal silicate solutions in the casing 1. In the particular example shown in FIG. 5, the method 30 comprises a step 32 of supplying a preflush 5 containing metal silicate mixture or solution through a tube 2 into a wellbore 16. The method 30 further comprises a step 34 of supplying a geopolymer mixture or solution comprising an aluminosilicate and an alkali material, such as, for example, an alkali hydroxide, through the tube 2 into the wellbore 16. The method 30 further comprises the step 36 of supplying a spacer 4 comprising the metal silicate mixture or solution through the tube 2 into the wellbore 16. In the example shown in FIG. 5, the method 30 further comprises the step 38 of removing the tube 2.

The geopolymer 6 may be supplied into the wellbore 16 through a tube 2. The tube 2 may be steel or other appropriate material. The unset geopolymer 6 is pushed through the tube 2 in the direction indicated by arrow 3. The geopolymer 6 may enter into the perforations 7 that are connected to the oil or gas bearing formation.

The geopolymer 6 may be preceded through the tube 2 by a preflush 5 comprising the metal silicate solution. The preflush 5 of metallic silicate solution added to the casing 1 assists to displace the water in the tubing and casing. The preflush 5 may remain partially throughout the casing 1 when the geopolymer 6 is added.

The geopolymer 6 may be followed by a spacer 4 comprising the metal silicate solution. In FIG. 2, a spacer 4 (or post flush) of metical silicate solution is shown being pushed into the geopolymer 6. The geopolymer 6 may be allowed to partially set and form a partially set geopolymer 10 with pore spaces 12 before the spacer 4. The spacer 4 may be used on a partially set geopolymer 10 to push the metallic silicate solution into the pore spaces 12. Further, the spacer 4 of metal silicate solution may assist with pushing the unset geopolymer 6 into place in the perforations 7 and casing 1. The direction of pumping of the spacer 4 is indicated by an arrow 3.

In an example, the tube 2 is removed before the step of allowing the mixture to partially set to form an at least partially set geopolymer 10 including pore spaces 12. In an embodiment shown in FIG. 3, the geopolymer plug 14 has been placed and the tubing 2 is being removed as indicated by the arrows 8. In FIG. 3, the geopolymer plug 14 of geopolymer is inside casing 1 with a connection through perforations 7 to the oil and gas bearing formation.

When the tube 2 is removed, the spacer 4 in the tubing will flow out of the tube 2 and on top of the geopolymer 6, creating a portion 9 of a combined amount of metallic silicate solution. The spacer 4 flows in this way because of gravity and differing fluid heights between the metal silicate solution in the casing and the metal silicate solution remaining in the tube 2. The combined preflush 5 and spacer 4 metal silicate solution collects on top of the geopolymer plug 14. The portion 9 of combined metal silicate solution is shown above the geopolymer plug 14. The portion 9 may also be added by injecting metal silicate solution after the tube 2 is raised. The spacer 4 of metal silicate solution may also not be injected or included, leaving only the preflush 5 above the geopolymer 6.

Similarly, the preflush may flow into the space formerly occupied by the tube when the tube is removed. Due to these flows, either of the preflush 5 or spacer 4 can be omitted while still providing a geopolymer 6 layer under a metal silicate mixture or solution. Alternatively, the tube could also be left in the geopolymer 6 while it sets and thereafter, if desired.

The geopolymer 6 may be provided in a lower portion of the wellbore 16 or casing 1, and the metal silicate solution is provided in a further portion 9 of the wellbore 16 immediately above the lower portion. The further portion 9 may be at least 5 meters in length. The further portion 9 may be between 5 meters and 50 meters in height. The height of the portion 9 of, as an example, 5-50 meters, a higher level may be used also and requires a larger quantity of metal silicate solution. A height of 50 meters may be used. A height of more than 50 meters may be used. A height of greater than 50 m could be desired to help with corrosion control of the wellbore. A height of less than 5 meters may also be used. Values could also be outside of this range, with higher values requiring more metal silicate and lower values risking excessive dilution of the metal silicate. The concentration of the metal silicates may also be about 20% by weight that is in the portion 9. The setting geopolymer plug 14 seals off the perforations 7 through the casing 1 into the oil and gas bearing formation. The casing 1 may be in a wellbore 16. The geopolymer plug 14 could alternatively be used in a wellbore 16 without the casing.

Typically, water is used to push the silicate solution as this is the most economical way to move the volume of geopolymer cement into place, though for example more metal silicate solution could be used instead of water. Direct contact of water with the setting geopolymer will leech the alkalinity (pH of the geopolymer paste equals 12-14 and the pH of the water is 6.5 to 7) from the setting geopolymer and create an area that does not fully solidify. Once the pH in the geopolymer drops enough, the geopolymerization process halts, hence the importance of keeping the alkalinity high in the setting geopolymer. Over time the silicate solution will mix fully with the water above it but initially there is a need to keep a highly concentrated solution of the metal silicate on top of the setting geopolymer to limit the transfer of alkalinity from the geopolymer to the liquid solution on top of the plug.

The goal is to isolate the geopolymer on both sides with a high alkaline metal silicate solution and as the tubing is removed the silicate solutions combine and sit on top of the setting geopolymer. Some mixing of the fluids will occur. It is expected that typically the silicate solution will not go all the way through the geopolymer; the geopolymer can be various sizes and shapes and could be small or very large. As the silicate moves through the geopolymer to seal it off, some silicate may get through.

Since the formation is porous, pressure on the surface will move the silicate solution into the setting geopolymer, this will accelerate closing off the porosity in the geopolymer. If there is a greater pressure on surface than in the formation the silicate solution will move into the geopolymer.

A description of the advantages and explanation of the operation of the method will now be described below.

The porosity and permeability that is inherent in geopolymers as they set comes from two sources. First, the geopolymer matrix contains leftover water present in the geopolymer reaction. Water does not actively participate in the reaction but is necessary to bring all the reactive species together to initiate the geopolymer process. Leftover water is entrained within the geopolymer matrix, the more water used, the larger the amount of porosity and permeability found within the matrix. Patents detailing the use of geopolymers in well bore applications work to minimize the use of water by using viscosity reducers, super-plasticizers, but a certain amount of water is required to achieve a desired viscosity of the overall mixture so it can be pumped and circulated into the well bore. Accordingly, water porosity is always going to be there.

Another aspect of porosity that is often overlooked is the reaction within the polysilate geopolymer during polymerization and the creation of hydrogen gas. Metals such as aluminum are favorable for the generation of hydrogen in the presence of water however the presence of an oxide film on the aluminum surface prevents the generation of hydrogen. A high alkaline environment such as found in a geopolymer solution can remove the oxide coating thereby allowing for the generation of hydrogen gas.

The gas continues to evolve as the sodium hydroxide slowly dissolves the silica alumina sources, such as fly ash, blast furnace slag, clays or silica. Elemental silica when present also can generate hydrogen gas and when used in high enough concentrations in the geopolymer formulation, the generation of hydrogen is so vigorous that the geopolymer has more of a sponge like consistency than a non-porous rock. The choice of an appropriate aluminosilicate source is important to minimizing the amount of hydrogen gas generated during the geopolymer reaction.

As the hydrogen gas is generated in situ, it actively contributes to the porosity of the geopolymer by forming “bubbles” within the matrix as it slowly hardens. The combination of water and hydrogen gas explains why there is an inherent porosity and permeability to all geopolymers.

A silica alumina source such as fly ash will have an undetermined amount of elemental aluminum and or elemental silica so the generation of hydrogen will happen regardless of the source of aluminosilicate. The use of water is necessary for a few reasons mentioned above but its main function is a carrier fluid for the geopolymer reaction, its presence cannot be minimized beyond a realistic point, to reduce the porosity of a geopolymer, other physical means must be employed to minimize the initial porosity.

U.S. Pat. No. 7,794,537 teaches that under wellbore conditions of high pressure (3000 psi) in combination with high temperature (90 deg. C.), after 21 days the permeability is below 6 micro Darcies. No mention is given to applying temperature or pressure above well bore conditions nor the permeability of the geopolymer if it was placed in a wellbore that was at a lower temperature or pressure.

The use of pressure has two main effects, it will compress the hydrogen gas, minimizing the size of the hydrogen bubble being created but also shift the equilibrium of the reaction towards the side of the reaction that does not generate a gas. Increasing the pressure on the geopolymer while it is setting will reduce the inherent porosity in the geopolymer matrix, but it will also decrease the size of the pores attributed to the hydrogen gas. To minimize hydrogen gas porosity it is beneficial to increase pressure to >500 psi while the geopolymer is hardening.

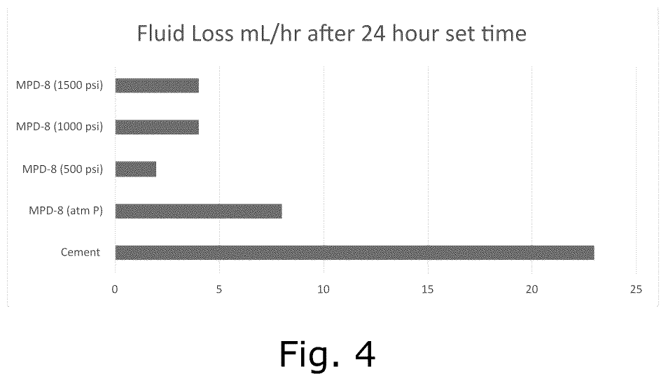

FIG. 4 shows a well bore geopolymer mixture that was set under varying pressures at a constant temperature of 60° C. and compared to cement set at 60° C. and 1000 psi. The term “MPD-8” is an internal name for the well bore geopolymer mixture which may in future be used as a trade name.

It was observed that a geopolymer set under atmospheric pressure at 60° C. had a porosity of 8 mL per hour, when measured at a pressure of 500 psi the fluid loss was recorded at 2 mL per hour, compressive strengths were recorded at 1650 psi and 2040 psi respectively. When the geopolymer is set at 1000 psi at 60° C., after 24 hrs the geopolymer fluid loss has dropped to 4 mL/hour. Using 1500 psi further reduced the porosity to <4 mL/hour. Increasing the pressure to greater than 500 psi while the geopolymer sets is recommended. The temperature of 60° C. was used for testing, but in actual practice temperature will depend on the ground temperature which can vary over a large range and can be above 150° C. for high temperature wells. Heat makes the geopolymer react faster and increases the compressive strength, which is expected to lower porosity.

While the latent heat associated with the downhole conditions controls the speed in which the geopolymer hardens, continued heat energy speeds up the geopolymer crosslinking process, so as the geopolymer tightens as it continues to react over time, the porosity and permeability decreases as the polymer ages. A higher bottomhole temperature means the geopolymer has greater chance to be less permeable than a geopolymer set at a lower temperature. This correlates directly to the compressive strength of the geopolymer, a stronger geopolymer is more developed and heat helps to improve the geopolymer reaction. Although both conditions should yield the same result over time, the higher temperature geopolymer should have a reduced porosity in a faster time frame.

Geopolymers set under pressure have comparable initial porosity values to standard cement mixtures. Cement after 24 hrs (set at 60° C.) was measured to have a fluid loss of 23 mL/hr, which dropped to <1 mL/hr after 7 days.

TABLES 1 and 2, shown below, provide data for geopolymers using sodium and potassium at different setting temperatures:

TABLE 1
Sodium MPD-8 (1760 kg/m\hat{ }3)

| | | | | | | | | | | 24 Hr. | Rheology |
|---|---|---|---|---|---|---|---|---|---|---|---|
| | | | | | | | | | | Porosity | (Dial |
| | | | | | | Compressive | | | | Flow | Reading) |
| Temp | GD/NaOH | NaOH | | | | Strength (MPa) | | | | Rate | RPM: |
| (deg. | Ratio (By | Molar | | WT | TT | 8 | 12 | 24 | 48 | (mL/30 | 300/200/ |
| C.) | Weight) | Conc. | Additives | (hh:mm) | (hh:mm) | Hrs. | Hrs. | Hrs. | Hrs. | min) | 100/6/3 |
| 25 | 1:10 | 8 | — | 0:12 | 1:14 | 4.1 | 5.1 | 6.4 | 7.3 | 44 | 300+/300+/321/43/32 |
| 40 | 1:10 | 6 | — | 0:37 | 0:50 | 4.8 | 5.6 | 6.9 | 8.1 | 20 | 281/203/118/28.1/22.0 |
| 60 | 1:10 | 4 | 1% Sugar | 1:51 | 2:11 | 5.4 | 6.0 | 7.3 | 8.8 | 2 | 216/156/91/21.6/16.9 |
| 80 | 1:10 | 2 | 1% Sugar | 0:56 | 1:20 | 7.3 | 8.5 | 10.0 | 12.0 | 0.2 | 166/120/70/16.6/13 |

TABLE 2
Potassium MPD-8 (1800 kg/m\hat{ }3)

| | | | | | | | | | | 24 Hr. | Rheology |
|---|---|---|---|---|---|---|---|---|---|---|---|
| | | | | | | | | | | Porosity | (Dial |
| | KASOLV16/ | | | | | Compressive | | | | Flow | Reading) |
| Temp | KOH | KOH | | | | Strength (MPa) | | | | Rate | RPM: |
| (deg. | Ratio (By | Molar | | WT | TT | 8 | 12 | 24 | 48 | (mL/30 | 300/200/ |
| C.) | Weight) | Conc. | Additives | (hh:mm) | (hh:mm) | Hrs. | Hrs. | Hrs. | Hrs. | min) | 100/6/3 |
| 25 | 1:10 | 8 | — | 3:02 | 4:34 | 2.3 | 4.0 | 7.3 | 10.0 | 25 | 301/225/136/14.4/8.0 |
| 40 | 1:10 | 6 | — | 2:09 | 2:43 | 6.7 | 8.0 | 9.3 | 10.3 | 12 | 218/153/84/7.4/4.1 |
| 60 | 1:10 | 4 | 1% Sugar | 2:42 | 3:31 | 7.2 | 9.2 | 11.0 | 12.0 | 5 | 158/104/52/3.8/2.1 |
| 80 | 1:10 | 2 | 1% Sugar | 2:40 | 3:52 | 7.6 | 9.2 | 11.0 | 11.5 | 0.4 | 114/71/31/2/1.1 |

In TABLES 1 and 2, GD™ is a sodium silicate product and KASOLV®16 is a potassium silicate product, both sold by PQ Corporation. In Canada, these are sold by PQ Corporation's Canadian subsidiary National Silicates. WT=working time and TT=thickening time are cement testing parameters. The compressive strength is measured after 8, 12, 24 and 48 hours of setting time. The porosity measurement is taken after 24 hours of setting time and is measured at the setting temperature (as indicated in the first column) and under +1000 psi of air pressure. The rheology measurements were taken using a rotational viscometer as the geopolymer mixture is mixed prior to setting, primarily for the purpose of determining if the mixture is stable enough to pump in the field.

The term geopolymer is applied to an inorganic backbone of ions made primarily from alumina and silica ions. To initiate the geopolymer process, two ingredients are needed, an alkali liquid and an alumino silicate rich mineral. The alkali liquid is typically a sodium or potassium-based liquid and the mineral is typically rich in silica and alumina and can be sourced from either geological or by-product type minerals. Alkali and alkali earth metal silicates can act as activators for the geopolymer process.

In a highly alkaline solution, the leaching of the silica and alumina ions from the solid surface to the growing gel phase creates many small covalently bonded molecules called oligomers. These oligomers in the gel state rearrange and polymerize into a highly 3D structure which undergoes precipitation once it reaches a critical size.

The main role for water in the geopolymer process is its use as a medium for the reaction and is responsible for creating macro-sized pores in the 3D geopolymer network. Reducing the amount of water used in the polymerization decreases the quantity of pores in the forming geopolymer which improves the compressive strength, reduces apparent porosity and the overall pore size.

This type of porosity related to leftover water can be further reduced by replacing the water from within the setting geopolymer matrix with an alkali metal silicate solution that continues the geopolymerization process, within that pore space. The reintroduction of reactive silicates into the pore spaces will restart the geopolymer chemical reaction in a very localized area. The concentration of the alkali metal silicates can be from 1 to 50%, ideally around 20% metal silicates in water is recommended.

Under bottomhole temperature and pressure conditions the water, once the geopolymer has hardened, has nowhere to go and therefore contributes to a connective porosity that makes geopolymers set (initially) under standard conditions, unsuitable for bottomhole use.

In an embodiment shown in FIGS. 2 and 3, geopolymer may be used for example to create an oil or gas well abandonment plug. This can be achieved operationally by using a metal silicate preflush 5 and a metal silicate post flush or spacer 4 to sandwich the pumped geopolymer 6. Once a volume of geopolymer is pumped through the tubing 2, the tubing is removed and a portion 9 of metal silicate solution now sits above the geopolymer. A height of 50m in the casing of the metal silicate solution is ideal. The geopolymer 6 is allowed to harden under a pressure greater than, for example, 100 psi, or in another example, greater than 500 psi. As the geopolymer 6 hardens to form partially set geopolymer 10 the pressure will slowly push the portion 9 of metal silicate solution into the hardening geopolymer 10. As the metal silicate replaces the water in the pore spaces, the increased concentration of alkalinity and silicate ions will quicken the geopolymer process and reduce the porosity of the overall geopolymer plug 14.

It is important that little or no water comes into contact with the hardening geopolymer 10 because of the diffusion of alkalinity from the geopolymer paste to the water. This has the effect of halting the geopolymer process in that area, and results in a section of the geopolymer that is unstable or has a very high porosity. A sufficiently large portion 9 of metal silicate solution above the geopolymer protects against any water damage.

The goal is to accelerate the reduction in porosity seen normally over a span of 21 to 45 days to between 1 and 7 days.

Removing the water is important to improving the overall integrity of the geopolymer in addition to the internal porosity. To achieve this the water in the geopolymer is replaced by displacement with a concentrated metal silicate solution once the geopolymer has hardened enough to have formed the initial pore spaces 12. It was found that after 6 hours, the geopolymer had hardened to the point where the water left in the geopolymer had formed a discrete porous network, fluid loss=40 mL/hr and could be displaced with a sodium silicate solution (20%/wt). Once displaced the geopolymer was allowed to sit undisturbed for 7 days at 1000 psi and Results comparing the water displaced geopolymer with an un-displaced sample showed an improvement in the porosity from 2 mL/hour to less than 1 mL/hour.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of producing a material, the method comprising the steps of:
providing a geopolymer mixture or solution comprising an aluminosilicate and an alkali material;
allowing the geopolymer mixture or solution to partially set to form an at least partially set geopolymer including pore spaces; and
exposing the at least partially set geopolymer to a metal silicate solution or mixture containing a metal silicate to allow the metal silicate to enter the pore spaces and react to form additional material within the pore spaces.

2. The method of claim 1 in which the geopolymer mixture or solution also includes an alkali silicate.

3. The method of claim 1 in which the metal silicate comprises sodium silicate, potassium silicate or lithium silicate.

4. The method of claim 1 in which the alkali material is an alkali hydroxide.

5. The method of claim 1 in which the metal silicate solution or mixture is a solution that includes a concentration of the metal silicates from 1 to 50% by weight.

6. The method of claim 1 in which the metal silicate solution or mixture is a solution that includes a concentration of the metal silicates from 15 to 30% by weight.

7. The method of claim 6 in which the concentration of the metal silicates is about 20% by weight.

8. The method of claim 1 in which the step of allowing the mixture to partially set to form an at least partially set geopolymer including pore spaces is carried out at a pressure of at least 100 psi.

9. The method of claim 8 in which the step of allowing the mixture to partially set to form an at least partially set geopolymer including pore spaces is carried out at a pressure of at least 500 psi.

10. The method of claim 9 in which the step of allowing the mixture to partially set to form an at least partially set geopolymer including pore spaces is carried out at a pressure of at least 1000 psi.

11. The method of claim 10 in which the step of allowing the mixture to partially set to form an at least partially set geopolymer including pore spaces is carried out at a pressure of about 1500 psi.

12. The method of claim 1 in which the step of allowing the mixture to partially set to form an at least partially set geopolymer including pore spaces is carried out at a pressure of greater than natural well bore conditions.

13. The method of claim 1 in which the step of allowing the mixture to partially set to form an at least partially set geopolymer including pore spaces is carried out at a pressure of less than 3000 psi.

14. The method of claim 1 in which the step of exposing the at least partially set geopolymer to a solution containing a metal silicate to allow the metal silicate to enter the pore spaces and react to form additional material within the pore spaces is carried out without a substantial change in pressure from the step of allowing the mixture to partially set to form an at least partially set geopolymer including pore spaces.

15. The method of claim 1 in which the material is formed in a wellbore to seal the wellbore.

16. The method of claim 15 in which the geopolymer mixture or solution is provided in a lower portion of the wellbore, and the metal silicate mixture or solution is provided in a further portion of the wellbore immediately above the lower portion.

17. The method of claim 16 in which the further portion is at least 5m in length.

18. The method of claim 17 in which the further portion is between 5 and 50m in length.

19. The method of claim 16 in which the geopolymer mixture or solution is supplied into the wellbore through a tube, the geopolymer mixture or solution preceded through the tube by a preflush comprising the metal silicate mixture or solution and followed by a spacer comprising the metal silicate mixture or solution.

20. The method of claim 19 further comprising the step of removing the tube before the step of allowing the mixture to partially set to form an at least partially set geopolymer including pore spaces.
